(19) United States
(12) Patent Application Publication
(10) Pub. No.: US 2026/0302263 A1
(43) Pub. Date: Oct. 1, 2026

(54) SOLID OXIDE FUEL CELL

(71) Applicant: NISSAN MOTOR CO., LTD., Yokohama-shi, Kanagawa (JP)

(72) Inventors: Keiji ICHIHARA, Kanagawa (JP); Toshiharu YAMATO, Kanagawa (JP)

(73) Assignee: NISSAN MOTOR CO., LTD., Yokohama-shi, Kanagawa (JP)

(21) Appl. No.: 18/879,426

(22) PCT Filed: Jun. 28, 2022
(86) PCT No.: PCT/JP2022/025857

§ 371 Date: Dec. 27, 2024

(51) Int. Cl. H01M 4/86; H01M 8/0273; H01M 8/12; H01M 8/1213

(52) U.S. Cl. CPC H01M 4/8605; H01M 8/0273; H01M 8/1213; H01M 2008/1293

(57) ABSTRACT

A solid oxide fuel cell in which a power generation cell composed of a first electrode layer, a solid electrolyte layer laminated on the first electrode layer, a second electrode layer laminated on the solid electrolyte layer, and a porous metal support layer supporting the first electrode layer is laminated in plural, includes: a metal frame provided under the porous metal support layer. The porous metal support layer includes a filled portion which is a region of which holes are filled with a filling material in an outer peripheral portion of the porous metal support layer thereof. The metal frame is bonded to the filled portion of the porous metal support layer with a bonding portion interposed therebetween.

### TECHNICAL FIELD

The present invention relates to a solid oxide fuel cell.

### BACKGROUND ART

In a solid oxide fuel cell (SOFC) including a power generation cell of a flat-plate type, in general, a frame forming a manifold for supplying gas is assembled under the power generation cell and a space between the power generation cell and the frame is sealed to maintain gas-tightness.

However, in an SOFC in which the power generation cell includes a porous metal support layer supporting an electrode, there is a concern that a gas may leak from a side surface of the metal support layer even when a space between a frame installed under the metal support layer and the metal support layer is sealed.

Meanwhile, when the frame is bonded to a dense electrolyte surface of the power generation cell, the gas leakage from a side surface of the power generation cell is prevented, but there is a concern that power generation performance may deteriorate since cracks are easily generated in an electrolyte at a bonding interface between the electrolyte surface and the frame.

In US2011-0104586 A1, a solid oxide fuel cell including a porous metal support is disclosed. In the solid oxide fuel cell, a density of a part of the metal support is increased, and a sealing member is surface-bonded to a high-density portion of the metal support to prevent a gas leakage from the metal support and a gas leakage from the space between the metal support and the frame.

### SUMMARY OF INVENTION

In a solid oxide fuel cell described in US2011-0104586A1, when a frame or a power generation cell is made thinner in order to reduce a size and a weight thereof, a power generation cell (a metal support) is easily deformed by a gas differential pressure or heating, and thus a sealing portion is easily peeled off. That is, there still is a concern that gas-tightness between the power generation cell and the frame may not be secured.

The present invention has been made in consideration of the above problems and is directed to providing of the solid oxide fuel cell in which the gas-tightness of a power generation cell is secured.

According to one embodiment of the present invention, a solid oxide fuel cell in which a power generation cell composed of a first electrode layer, a solid electrolyte layer laminated on the first electrode layer, a second electrode layer laminated on the solid electrolyte layer, and a porous metal support layer supporting the first electrode layer is laminated in plural is provided. The solid oxide fuel cell includes a metal frame provided under the porous metal support layer, and the porous metal support layer includes a filled portion which is a region of which holes are filled with a filling material in an outer peripheral portion of the porous metal support layer thereof. The metal frame is interposed with a bonding portion to be bonded to the filled portion of the porous metal support layer, and the bonding portion includes a first bonding portion formed along the outer peripheral portion of the porous metal support layer and a second bonding portion disposed to be spaced apart from the first bonding portion at an outer peripheral side than the first bonding portion.

### BRIEF DESCRIPTION OF DRAWINGS

FIG. 1 is an exploded perspective view of a solid oxide fuel cell according to a first embodiment of the present invention.

FIG. 2 is an exploded perspective view of a cell unit.

FIG. 3 is an enlarged schematic view of a bonding area of a power generation cell and a frame.

FIG. 4 is a cross-sectional view of a porous metal support layer.

FIG. 5 is an enlarged schematic view of a bonding area of a power generation cell and a frame according to a modified example.

FIG. 6 is a cross-sectional view of a porous metal support layer of a solid oxide fuel cell according to a first modified example of the first embodiment.

FIG. 7 is a cross-sectional view of a porous metal support layer of a solid oxide fuel cell according to another modified example.

FIG. 8 is a cross-sectional view of a porous metal support layer of a solid oxide fuel cell according to a second modified example of the first embodiment.

FIG. 9 is a cross-sectional view of a porous metal support layer of a solid oxide fuel cell according to a third modified example of the first embodiment.

FIG. 10 is a cross-sectional view of a porous metal support layer of a solid oxide fuel cell according to still another modified example.

FIG. 11 is a cross-sectional view of a porous metal support layer of a solid oxide fuel cell according to a fourth modified example of the first embodiment.

FIG. 12 is a cross-sectional view of a porous metal support layer of a solid oxide fuel cell according to yet another modified example.

FIG. 13 is a cross-sectional view of a porous metal support layer of a solid oxide fuel cell according to still yet another modified example.

FIG. 14 is an enlarged schematic view of a bonding area of a power generation cell and a frame of a solid oxide fuel cell according to a second embodiment.

FIG. 15 is an enlarged schematic view of a bonding area of a power generation cell and a frame of a solid oxide fuel cell according to a third embodiment.

FIG. 16 is a cross-sectional view of a porous metal support layer of the solid oxide fuel cell according to the third embodiment.

### DESCRIPTION OF EMBODIMENTS

Hereinafter, embodiments of the present invention will be described with reference to drawings and the like.

### First Embodiment

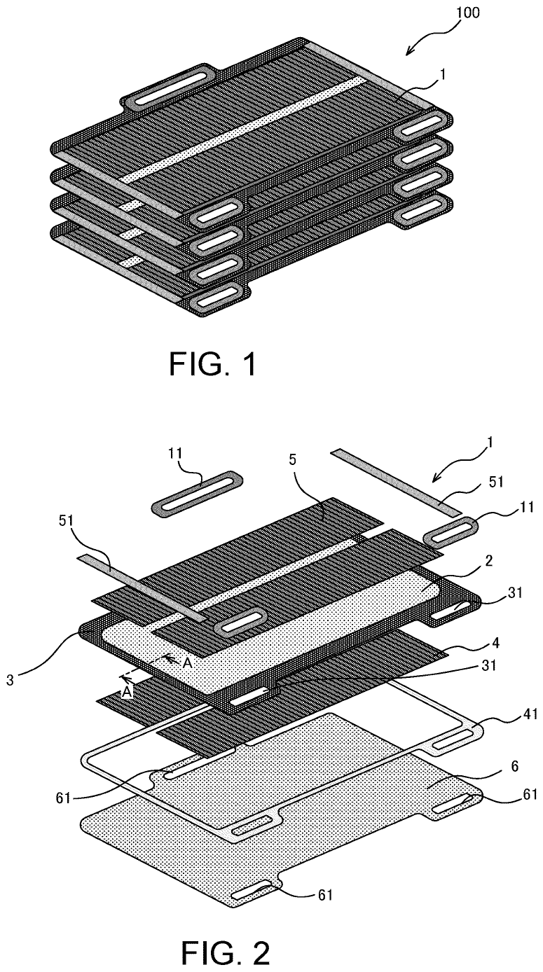

FIG. 1 is an exploded perspective view showing a solid oxide fuel cell 100 (hereinafter, also simply referred to as “a fuel cell”) according to a first embodiment of the present invention. As shown in FIG. 1, the solid oxide fuel cell 100 is composed by laminating a plurality of cell units 1 in a vertical direction. Here, the solid oxide fuel cell 100 of the present embodiment is mainly installed in a vehicle and the like but is not limited thereto.

FIG. 2 is an exploded perspective view of the cell unit 1 constituting the solid oxide fuel cell 100. As shown in FIG. 2, the cell unit 1 includes a power generation cell 2, a frame 3, an anode flow path forming member 4, a cathode flow path forming member 5, a separator 6, an anode spacer 41, a cathode spacer 51, and the like.

The power generation cell 2 is composed by a membrane electrode assembly in which an anode layer (first electrode layer) is disposed at one surface of a solid electrolyte layer and a cathode layer (second electrode layer) is disposed at the other surface thereof. In the present embodiment, a lower surface side of the power generation cell 2 is the anode layer, and an upper surface side is the cathode layer. In the power generation cell 2, an anode gas (fuel gas) and a cathode gas (air) are supplied, and the power generation cell 2 generates power on the basis of an electrode reaction in the anode layer and the cathode layer. In addition, as described below, the power generation cell 2 includes a porous metal support layer supporting the electrode layer. That is, the solid oxide fuel cell 100 of the present embodiment is so-called a metal support type fuel cell.

In addition, a peripheral portion of the power generation cell 2 is bonded and supported by a frame 3 (frame body) made of metal installed under the power generation cell 2, and, accordingly, the power generation cell 2 is fixed to the frame 3 (metal frame). The frame 3 includes a plurality of protrusions installed to extend from an outer peripheral edge, and a hole portion 31 is formed on the protrusions.

The anode flow path forming member 4 is made of a conductive material such as a metal, is disposed between the anode layer of the power generation cell 2 and the separator 6 to be described later, and forms an anode flow path through which the fuel gas flows on the anode layer side of the power generation cell 2. The anode flow path forming member 4 is formed in so-called a waveform shape in which irregularities extending in a straight line in a transverse direction of the power generation cell 2 are repeatedly formed in a longitudinal direction. Accordingly, a plurality of anode flow paths are divided between the anode layer and the separator 6 of the power generation cell 2.

The cathode flow path forming member 5 is made of a conductive material such as a metal, is disposed between the cathode layer of the power generation cell 2 and the separator 6 (of an adjacent cell unit 1), and forms a cathode flow path through which the cathode gas (air) flows at the cathode layer side of the power generation cell 2. The cathode flow path forming member 5, like the anode flow path forming member 4, is formed in a waveform shape, and a plurality of cathode flow paths are divided between the cathode layer and the separator 6 of the power generation cell 2.

In addition, as shown in FIG. 2, the anode flow path forming member 4 forming the anode flow path and the cathode flow path forming member 5 forming the cathode flow path are divided into two and are spaced apart from each other but is not limited thereto. For example, the two divided flow path members may be disposed close to each other without having a gap therebetween. In addition, the anode flow path and the cathode flow path each may be formed by one member.

The separator 6 is a plate-shaped member having a conductivity and on one surface (upper surface) of which is conductively bonded to the anode flow path forming member 4. Accordingly, the separator 6 and the anode of the power generation cell 2 are electrically connected via the anode flow path forming member 4. Meanwhile, the other surface (lower surface) of the separator 6 is bonded to a cathode flow path forming member 5 of the adjacent cell unit 1.

In addition, the separator 6 has a plurality of protrusions installed to extend from an outer peripheral edge to protrude, and, on the protrusion portion, a hole portion 61 is formed at a position corresponding to the hole portion 31 of the frame 3. By overlapping the hole portion 61 of the separator 6 and the hole portion 31 of the frame 3, a through-hole through which the fuel gas supplied to the anode flow path flows and a through-hole through which the fuel gas exiting from the anode flow path flows are formed. A sealing member 11 is provided around the through-hole formed by overlapping the hole portion 61 of the separator 6 and the hole portion 31 of the frame 3.

The anode spacer 41 is a frame body laminated on the outer periphery of the separator 6 and is disposed between the power generation cell 2 and the separator 6 to ensure a height of the anode flow path. The anode spacer 41 is disposed so that an outer shape thereof overlaps the frame 3 fixing the power generation cell 2 and the separator 6.

The cathode spacer 51 is disposed at both ends of the cathode flow path forming member 5 in the longitudinal direction and ensures the height of the cathode flow path while sealing the both ends of the cathode flow path forming member 5 in the longitudinal direction.

In the solid oxide fuel cell 100 configured as above, the fuel gas (the anode gas) is supplied from the anode flow path to the anode layer side of the power generation cell 2, and the air (the cathode gas) is supplied from the cathode flow path to the cathode layer side of the power generation cell 2.

However, there is a concern that the power generation performance may deteriorate when the fuel gas (the anode gas) supplied to the anode layer and the cathode gas supplied to the cathode layer are mixed. Therefore, it is necessary to form a sealing structure that prevents a gas leakage from the power generation cell 2 or the gas flow path (the anode flow path, the cathode flow path).

In this respect, in a solid oxide fuel cell including a power generation cell of a flat-plate shape, in general, a frame is assembled under the power generation cell and a space between the power generation cell and the frame is sealed to prevent a gas leakage.

However, in the solid oxide fuel cell in which the power generation cell includes a porous metal support layer supporting an electrode, even when a space between the frame installed under the metal support layer and the metal support layer is sealed, there is a concern that the gas may leak from a side surface of the porous metal support layer.

Meanwhile, when the frame is bonded to a dense electrolyte surface of the power generation cell and a space between the electrolyte surface and the frame is sealed, the gas leakage from a side surface of the power generation cell may be prevented, but there is a concern that the power generation performance may deteriorate since cracks are easily generated in an electrolyte at a bonding interface.

On the contrary, it is considered a density of a part of the metal support layer is increased and a sealing member preventing the gas leakage between the metal support layer and the frame is surface-bonded to a high-density portion of the metal support layer to prevent the gas leakage from the side surface of the power generation cell and the gas leakage between the power generation cell and the frame. However, even in this case, in order to reduce a size and weight, when the frame or the power generation cell is made thinner, the power generation cell (the metal support layer) is likely to be deformed by a gas differential pressure or heating, and there is a concern that the sealing portion may be peeled off. That is, there still is a concern that a gas leak may occur.

Therefore, in the present embodiment, a filled portion which is a region of which holes are filled with a filling material is provided in an outer peripheral portion of the porous metal support layer supporting the electrode layer, and the frame 3 is bonded to the filled portion with two bonding portions interposed therebetween. Specifically, the frame 3 is bonded to the filled portion by a first bonding portion formed along the outer peripheral portion of the porous metal support layer and a second bonding portion disposed to be spaced apart from the first bonding portion at an outer peripheral side than the first bonding portion. As such, by installing the filled portion in which the holes are filled to the porous metal support layer, the gas leakage from the side surface of the porous metal support layer may be prevented. In addition, by forming two bonding portions bonding the frame 3 and the porous metal support layer in the filled portion, a displacement (deformation) of the filled portion is prevented, and a gas leakage between the power generation cell 2 and the frame 3 is prevented. Therefore, gas-tightness of the power generation cell 2 is secured, and the deterioration of power generation performance is prevented.

Hereinafter, a bonding structure of the power generation cell 2 and the frame 3 are described in more details.

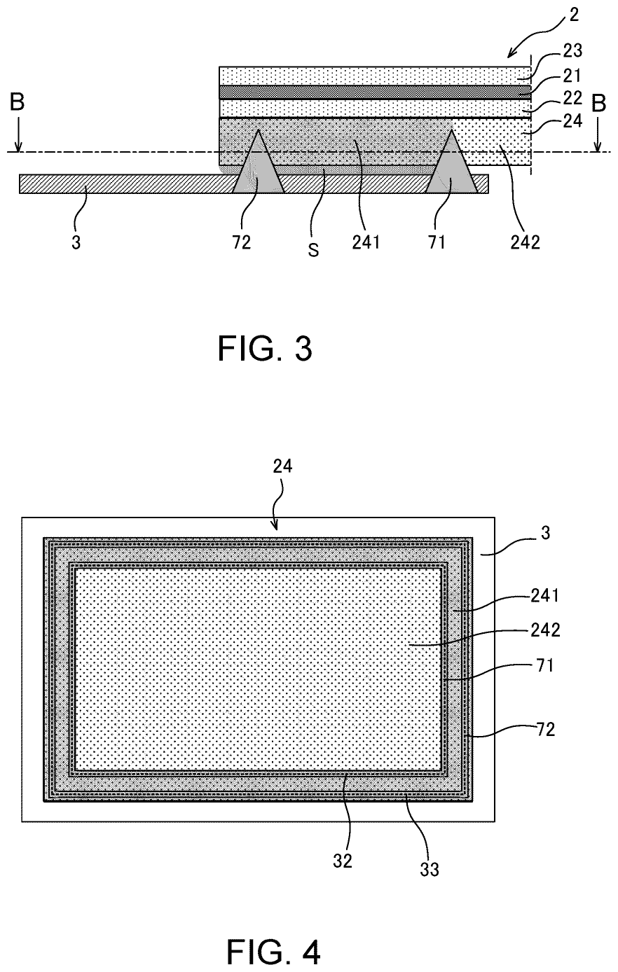

FIG. 3 is an enlarged schematic view at a bonding area of the power generation cell 2 and the frame 3 and is a cross-sectional view taken along line A-A in FIG. 2.

As shown in FIG. 3, the power generation cell 2 includes a solid electrolyte layer 21, an anode layer 22 (first electrode layer) disposed at one side of the solid electrolyte layer, a cathode layer 23 (second electrode layer) disposed at the other side of the solid electrolyte layer 21, and a porous metal support layer 24 (metal support, hereinafter, also simply referred to as a metal support layer) supporting the anode layer 22.

The solid electrolyte layer 21 is formed by a dense ceramic layer. Here, the ceramics refers to a sintered body of an inorganic material and is a concept that includes not only a non-metal oxide but also a metal oxide. The solid electrolyte layer 21 may be configured to be able to conduct an oxide ion, while being impermeable to a gas. For example, the solid electrolyte layer 21 may be formed by a solid oxide ceramic. The solid oxide ceramics are not specifically limited thereto but may be, for example, a zirconia-containing material. The zirconia-containing material may be stabilized zirconia doped with yttria, neodymium oxide, samarium, gadolinium, scandium, etc.

The anode layer 22 has a porous structure and is formed of, for example, a metal such as nickel (Ni) and an oxide such as yttria-stabilized zirconia (YSZ), but is not limited thereto, and any already known material may be used.

The cathode layer 23 has a porous structure and is formed of, for example, lanthanum strontium cobalt complex oxide (LSC), lanthanum strontium cobalt iron oxide (LSCF), or the like, but is not limited thereto, and any already known material may be used.

The metal support layer 24 has a porous structure and is formed by, for example, ferritic stainless steel, but is not limited thereto, and any already known material may be used. The metal support layer 24 is provided to support the anode layer 22 and function as a structural member to reinforce the strength of the power generation cell 2.

In addition, the metal support layer 24 includes a filled portion 241 which is a region of which holes are filled with a filling material and a porous portion 242 which is a region in which the filling material is not filled. The filled portion 241 is formed on an outer peripheral portion of the metal support layer 24. The filling material filled in the filled portion 241 is composed of an insulating material having a smaller linear expansion coefficient than that of the material constituting the metal support layer 24, and may use particles composed of, for example, alumina, zirconia (ZrO₂), yttria-stabilized zirconia (YSZ), scandia-stabilized zirconia (ScSZ), or the like.

As such, since the dense filled portion 241 filled with the filling material is formed in the outer peripheral portion of the metal support layer 24, a gas leakage from a side surface of the metal support layer 24 is prevented.

Under the metal support layer 24, the frame 3 made of a metal material supporting and fixing the power generation cell 2 is included. As shown in FIG. 3, in the metal support layer 24, a first bonding portion 71 disposed at an inner peripheral side of the filled portion 241 and a second bonding portion 72 disposed to be spaced apart from the first bonding portion at an outer peripheral side are formed. The frame 3 is welded (bonded) to the metal support layer 24 at the first bonding portion 71 and the second bonding portion 72.

As such, since the filled portion 241 of the metal support layer 24 and the frame 3 are bonded with two bonding portions 71 and 72 interposed therebetween, a displacement (deformation) of the filled portion 241 is suppressed, and the filled portion 241 and the frame 3 are prevented from being peeled off.

Here, an average particle diameter of the filling material filled into holes is smaller than an average hole diameter of core holes of the metal support layer 24. Accordingly, the filling material may be densely filled into the metal support layer 24.

In addition, as shown in FIG. 3, the filling material is also filled in a space S (gap) surrounded by the bonding portion 71, the bonding portion 72, the metal support layer 24, and the frame 3. Accordingly, the gas-tightness between the filled portion 241 and the frame 3 becomes higher. However, the metal support layer 24 and the frame 3 may be bonded without a gap (i.e., without the space S existing).

In addition, as described above, since the filling material has a linear expansion coefficient smaller than that of a material constituting the metal support layer 24, even when the filling material thermal expands at high temperatures, the metal support layer 24 is not pressurized. That is, the metal support layer 24 is prevented from being pressurized and damaged by thermal expansion of the filling material.

In addition, since the filling material is composed of an insulating material, even when the filling material leaks from the side surface of the metal support layer 24 and connects to the electrode layer, a short circuit does not occur.

Here, as a manufacturing process, the filling material is filled from a side surface of the metal support layer 24 after welding the frame 3 to the metal support layer 24. Accordingly, the holes of the outer peripheral side of the metal support layer 24 may be reliably filled, thereby more reliably preventing a gas leakage from the side surface of the metal support layer 24. In addition, by filling the filling material after welding, it is possible to prevent quality deterioration caused by welding in a state in which the insulation material (the filling material) is mixed with the metal support layer 24.

FIG. 4 is a cross-sectional view of the entire metal support layer 24 taken along line B-B in FIG. 3.

As shown in FIG. 4, the first bonding portion 71 to which the frame 3 and the metal support layer 24 are bonded, when seen in a laminating direction of the cell unit 1, is formed continuously over the entire circumference on a line (first annular line 32) that forms a single ring shape along the outer peripheral portion (the filled portion 241) of the metal support layer 24.

In addition, the second bonding portion 72 to which the frame 3 and the metal support layer 24 are bonded, when seen in the laminating direction of the cell unit 1, is formed continuously over the entire circumference on a line (second annular line 33) that forms a single ring shape along the outer peripheral portion (the filled portion 241) of the metal support layer 24 and is located at the outer periphery than the first annular line 32.

As such, the frame 3 is bonded to the filled portion 241 of the metal support layer 24 with the first bonding portion 71 formed along the outer peripheral portion of the metal support layer 24 and the second bonding portion 72 disposed to be spaced apart from the first bonding portion 71 at the outer peripheral side than the first bonding portion interposed therebetween. Since the frame 3 and the filled portion 241 are bonded by two bonding portions 71 and 72, a displacement (deformation) of the filled portion 241 due to a gas differential pressure or heating and the like is suppressed, and the filled portion 241 and the frame 3 are prevented from being peeled off. That is, a gas leakage between the metal support layer 24 and the frame 3 may be prevented.

As described above, the gas leakage from the side surface of the metal support layer 24 is prevented by the filled portion 241 formed on the outer peripheral portion of the metal support layer 24, and the gas leakage between the metal support layer 24 and the frame 3 is prevented by the first bonding portion 71 and the second bonding portion 72 formed along the outer peripheral portion of the metal support layer 24. Therefore, the gas-tightness of the power generation cell 2 is secured, and the deterioration of power generation performance is prevented.

According to the solid oxide fuel cell 100 of the first embodiment described above, the following effects may be obtained.

In the solid oxide fuel cell 100, the power generation cell 2 includes the porous metal support layer 24 supporting the anode layer 22 (the first electrode layer), and the porous metal support layer 24 includes the filled portion 241 which is a region of which holes are filled with the filling material at the outer peripheral portion. In addition, the metal frame 3 provided under the porous metal support layer 24 is bonded to the filled portion 241 of the porous metal support layer 24 with the bonding portion interposed therebetween. The bonding portion includes the first bonding portion 71 formed along the outer peripheral portion of the porous metal support layer 24 and the second bonding portion 72 disposed to be spaced apart from the first bonding portion 71 at an outer peripheral side than the first bonding portion 71. As such, by forming the filled portion 241 in which holes are filled in the outer circumference portion of the porous metal support layer 24, the gas leakage from the side surface of the porous metal support layer 24 is prevented. In addition, since the metal frame 3 and the filled portion 241 of the porous metal support layer 24 are bonded by two bonding portions 71 and 72, a displacement (deformation) of the filled portion 241 due to a gas differential pressure or heating and the like is suppressed, and the filled portion 241 and the frame 3 are prevented from being peeled off. That is, the gas leakage between the porous metal support layer 24 and the metal frame 3 is prevented. Therefore, the gas-tightness of the power generation cell 2 is secured, and the deterioration of power generation performance is prevented.

The solid oxide fuel cell 100 includes the first and second bonding portions 71 and 72 bonding the metal frame 3 and the porous metal support layer 24, the first bonding portion 71 is disposed on the first annular line 32 which forms a ring shape along the outer peripheral portion of the porous metal support layer 24 when seen in the laminating direction, and the second bonding portion 72 is disposed on the second annular line 33 which is an annular line positioned at the outer periphery than the first annular line 32. As such, since the bonding portions 71 and 72 bonding the metal frame 3 and the porous metal support layer 24 are disposed on the annular lines 32 and 33 of the outer peripheral portion of the porous metal support layer 24, a displacement (a deformation) of the filled portion 241 due to a gas differential pressure or heating and the like is suppressed over the entire circumference of the outer peripheral portion of the porous metal support layer 24, so that the filled portion 241 and the frame 3 are further prevented from being peeled off.

The solid oxide fuel cell 100 includes the first and the second bonding portions 71 and 72 bonding the metal frame 3 and the porous metal support layer 24, the first bonding portion 71 is disposed continuously over the entire circumference on the first annular line 32 along the outer peripheral portion of the porous metal support layer 24, and the second bonding portion 72 is disposed continuously over the entire circumference on the second annular line 33 located at the outer periphery than the first annular line 32. Accordingly, a displacement (deformation) of the filled portion 241 due to a gas differential pressure or heating and the like is suppressed over the entire circumference of the outer peripheral portion of the porous metal support layer 24, and the filled portion 241 and the frame 3 are further prevented from being peeled off.

In the solid oxide fuel cell 100, the porous metal support layer 24 includes the filled portion 241 in which the holes are filled with the filling material in the outer peripheral portion, and the linear expansion coefficient of the filling material is smaller than the linear expansion coefficient of a porous metal material constituting the porous metal support layer 24. Accordingly, the metal support layer 24 is prevented from being pressurized and damaged due to thermal expansion of the filling material.

Here, in the present embodiment, the lower surface side of the power generation cell 2 is set as the anode layer (the first electrode layer) and the upper surface side is set as the cathode layer (the second electrode layer), but the embodiment is not necessarily limited thereto, and the lower surface side of the power generation cell 2 may be set as the cathode layer, and the upper surface side may be set as the anode layer.

In addition, in the present embodiment, the configuration is such that the metal support layer 24 is included on the anode layer 22 side, but is not necessarily limited thereto. That is, it is sufficient that the metal support layer 24 should be formed at least one electrode side, and the metal support layer 24 and the metal frame 3 are bonded to each other.

In addition, the configurations such as the anode flow path and the cathode flow path described in FIG. 2 are examples, but is not particularly limited thereto.

In addition, in the present embodiment, the first bonding portion 71 is formed at a position where the filled portion 241 is positioned but is not necessarily limited thereto. For example, the first bonding portion 71 may be formed over the filled portion 241 and the porous portion 242, or may be formed in the porous portion 242 near the filled portion 241.

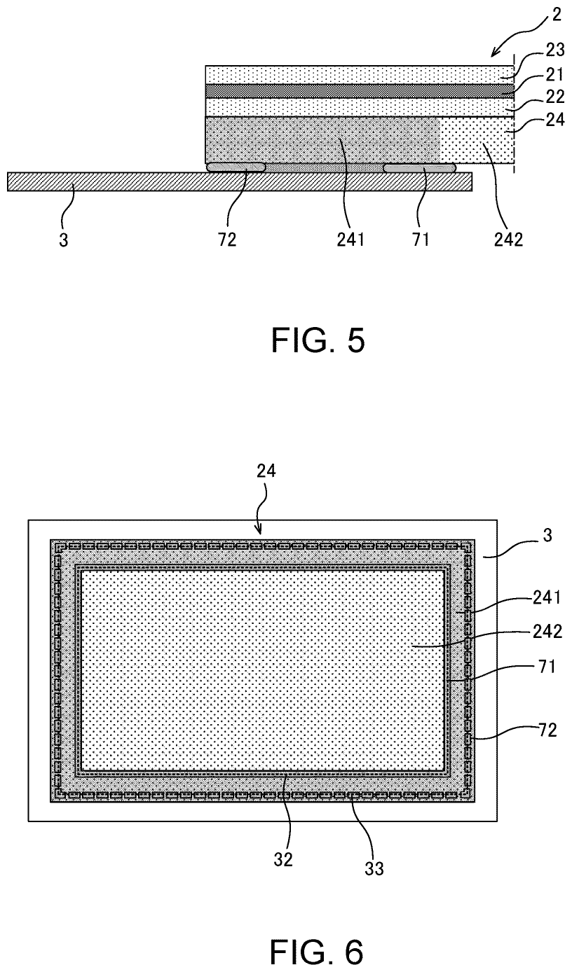

In addition, as in the present embodiment, the metal frame 3 is preferably bonded to the porous metal support layer 24 by welding, but a bonding method is not necessarily limited thereto. For example, as shown in the cross-sectional view of the power generation cell 2 in FIG. 5, the metal frame 3 may be bonded to the porous metal support layer 24 by soldering.

In addition, in the present embodiment, the filling material is filled in the metal support layer 24 to form the filled portion 241 in the metal support layer 24 but is not necessarily limited thereto. For example, the filling material may be filled not only in the metal support layer 24 but also in the electrode layer (the anode layer 22) laminated on the metal support layer 24 to form the filled portion 241 in the electrode layer as well. Accordingly, a gas leakage from the electrode layer having a porous structure may be prevented, thereby further securing the gas-tightness of the power generation cell 2. However, since the electrode layer is very thin compared to the metal support layer 24, even when the configuration of the present embodiment forms the filled portion 241 only on the metal support layer 24, a gas leakage may be prevented.

### First Modified Example of First Embodiment

Referring to FIG. 6, a solid oxide fuel cell 100 according to a first modified example of the first embodiment is described. In the present embodiment, it is different from the first embodiment in that a second bonding portion 72 is formed discontinuously. In addition, the same drawing symbols are cited to the same elements as in the first embodiment, and the description will be omitted.

FIG. 6 is a cross-sectional view of a porous metal support layer 24 of the solid oxide fuel cell 100 according to the present modified example and corresponds to the cross-sectional view of the entire metal support layer 24 along line B-B in FIG. 3.

As shown in FIG. 6, in the present modified example, the second bonding portion 72 is disposed discontinuously on a second annular line 33. Specifically, the second bonding portion 72 is disposed in a dotted line shape with intervals. That is, the frame 3 is welded in the dotted line shape to the metal support layer 24 at the second bonding portion 72 on the second annular line 33. Accordingly, the metal support layer 24 is suppressed from being deformed due to heat-deformation during welding compared to a case where the second bonding portion 72 is formed continuously. Therefore, the gas-tightness of the power generation cell 2 is strengthened, and a gas leakage between the porous metal support layer 24 and the metal frame 3 is further prevented.

In addition, since a portion of an outer peripheral portion of the metal support layer 24 where the second bonding portion 72 is disconnected is also sealed by the filling material, a gas leakage between the porous metal support layer 24 and the metal frame 3 is prevented by the filling material at the corresponding portion as well.

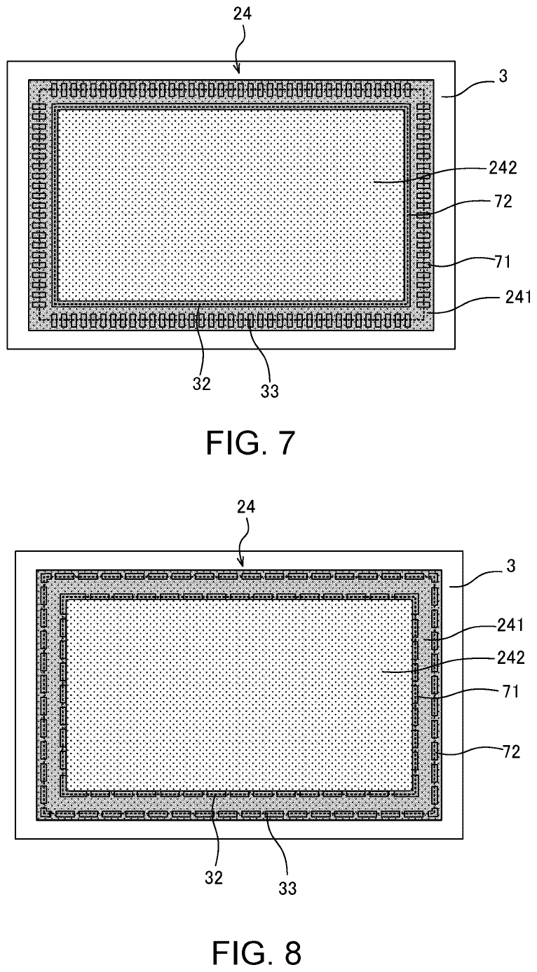

In addition, in the present modified example, the second bonding portion 72 is disposed in the dotted line shape with intervals but is not necessarily limited thereto. For example, as shown in the cross-sectional view of the porous metal support layer 24 of FIG. 7, the second bonding portion 72 may be disposed in plural to be spaced apart from each other on the second annular line 33 and may be disposed to extend in a direction perpendicular to a first annular line 32. Even in this configuration, a deformation of the metal support layer 24 due to a heat-deformation is suppressed during welding.

### Second Modified Example of First Embodiment

Referring to FIG. 8, a solid oxide fuel cell 100 according to a second modified example of the first embodiment is described. In the present embodiment, it is different from other embodiments in that a first bonding portion 71 is formed discontinuously. In addition, the same drawing symbols are cited to the same elements as in other embodiments, and the description will be omitted.

FIG. 8 is a cross-sectional view of a porous metal support layer 24 of the solid oxide fuel cell 100 according to the present modified example and corresponds to a cross-sectional view of the entire metal support layer 24 taken along line B-B in FIG. 3.

As shown in FIG. 8, in the present modified example, the first bonding portion 71 is discontinuously disposed on a first annular line 32. Specifically, the first bonding portion 71 is disposed in the dotted line shape with intervals. That is, a frame 3 is welded to the metal support layer 24 in the dotted line shape at the first bonding portion 71 on the first annular line 32.

Meanwhile, as in the first modified example of the first embodiment, the second bonding portion 72 is also disposed in the dotted line shape with intervals. That is, the frame 3 is welded in the dotted line shape to the metal support layer 24 at the second bonding portion 72 on a second annular line 33

In addition, the first bonding portion 71 and the second bonding portion 72 are disposed in a zigzag shape when a cell unit 1 is seen in a laminating direction so that a portion where the bonding portion is disconnected does not overlap. That is, the first bonding portion 71 and the second bonding portion 72 are disposed so that, when seen in the laminating direction, a bonding portion exists at least on any one of an outer peripheral side or an inner peripheral side of a filled portion 241 of the metal support layer 24.

As such, by arranging both the first bonding portion 71 and the second bonding portion 72 in the dotted line shape with intervals, a deformation of the metal support layer 24 due to heat-deformation is further suppressed during welding. In addition, when seen in the laminating direction, since the first bonding portion 71 and the second bonding portion 72 are disposed in the zigzag shape so that a bonding portion exists at least at any one of the outer peripheral side and the inner peripheral side of the filled portion 241 of the metal support layer 24, a displacement of the filled portion 241 due to a gas differential pressure or heating is suppressed. Therefore, the gas-tightness of the power generation cell 2 is strengthened, and a gas leakage between the porous metal support layer 24 and the metal frame 3 is further prevented.

In addition, in the present modified example, both the first bonding portion 71 and the second bonding portion 72 are disposed in the dotted line shape with intervals but is not necessarily limited thereto, and only the first bonding portion 71 may be disposed in the dotted line shape with intervals, and the second bonding portion 72 may be provided continuously over the entire circumference on the second annular line 33. In addition, the first bonding portion 71 may be disposed in the dotted line shape with intervals, and the second bonding portion 72 may be disposed in plural to be spaced apart from each other on the second annular line 33 and may be provided so as to extend in a direction perpendicular to the first annular line 32. Even with the configuration as such, a deformation of the metal support layer 24 due to a heat-deformation is suppressed during welding.

### Third Modified Example of First Embodiment

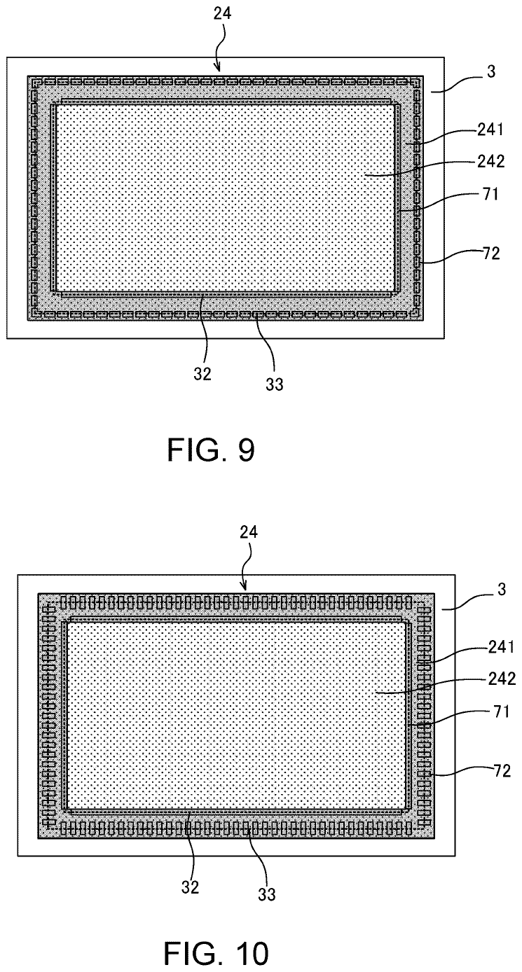

Referring to FIG. 9, a solid oxide fuel cell 100 according to a third modified example of the first embodiment is described. In the present embodiment, it is different from other embodiments in that a first bonding portion 71 is formed discontinuously in an edge portion. In addition, the same drawing symbols are cited to the same elements as in other embodiments, and the description will be omitted.

FIG. 9 is a cross-sectional view of a porous metal support layer 24 of the solid oxide fuel cell 100 according to the present modified example and corresponds to the cross-sectional view of the entire metal support layer 24 taken along line B-B in FIG. 3.

As shown in FIG. 9, in the present modified example, the first bonding portion 71 is disposed on a first annular line 32 so that an edge portion is discontinuous. That is, in the edge portion of the first annular line 32, a frame 3 is not bonded to the metal support layer 24. In general, when there is a bending portion in a bonding portion, a bonding work (welding, etc.) becomes difficult, but in the present modified example, since there is no bending portion in the first bonding portion 71, bonding (welding, etc.) between the frame 3 and the metal support layer 24 becomes easy.

In addition, in FIG. 9, a second bonding portion 72 is disposed in the dotted line shape with intervals but is not limited thereto. For example, the second bonding portion 72 may be disposed continuously over the entire circumference on the second annular line 33, or, as shown in FIG. 10, the second bonding portion 72 may be disposed in plural so as to extend in a direction perpendicular to the first annular line 32 to be spaced apart from each other.

### Fourth Modified Example of First Embodiment

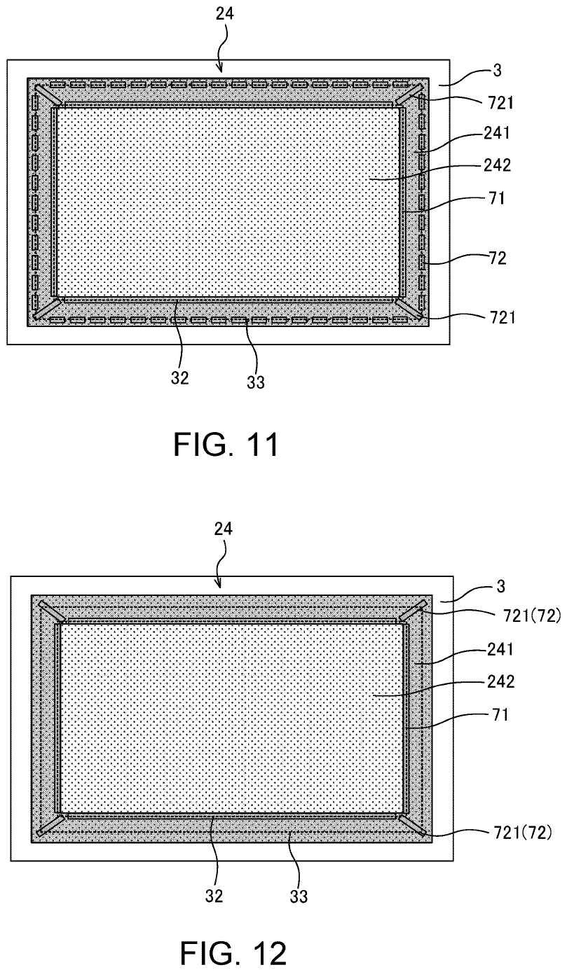

Referring to FIG. 11, a solid oxide fuel cell 100 according to a fourth modified example of the first embodiment is described. In the present embodiment, it is different from the third modified example of the first embodiment in that the second bonding portion 72 includes a diagonal bonding portion 721 formed to extend diagonally from an edge portion. In addition, the same drawing symbols are cited to the same elements as in other embodiments, and the description will be omitted.

FIG. 11 is a cross-sectional view of a porous metal support layer 24 of the solid oxide fuel cell 100 according to the present modified example.

As shown in FIG. 11, in the present modified example, a first bonding portion 71 is disposed so that the edge portion is discontinuous on a first annular line 32, and the second bonding portion 72 is disposed in the dotted line shape on a second annular line 33. In addition, the second bonding portion 72 includes a diagonal bonding portion 721 formed to extend diagonally from the edge portion of the second annular line 33. Accordingly, in the edge portion where the first bonding portion 71 is disconnected, a bonding between a frame 3 and a filled portion 241 of a metal support layer 24 is strengthened by the diagonal bonding portion 721 so that a displacement of the filled portion 241 due to a gas differential pressure or a heating is suppressed. Therefore, the gas-tightness of a power generation cell 2 is strengthened, and a gas leakage between the porous metal support layer 24 and the metal frame 3 is further prevented. In addition, since there is no bending portion in both the first bonding portion 71 and the second bonding portion 72, bonding (welding, etc.) between the frame 3 and the metal support layer 24 becomes easy.

Here, in the present modified example, the second bonding portion 72 is disposed in the dotted line shape with intervals but is not limited thereto, and for example, as shown in FIG. 12, the second bonding portion 72 may be formed only as the diagonal bonding portion 721 formed to extend diagonally from the edge portion of the second annular line 33.

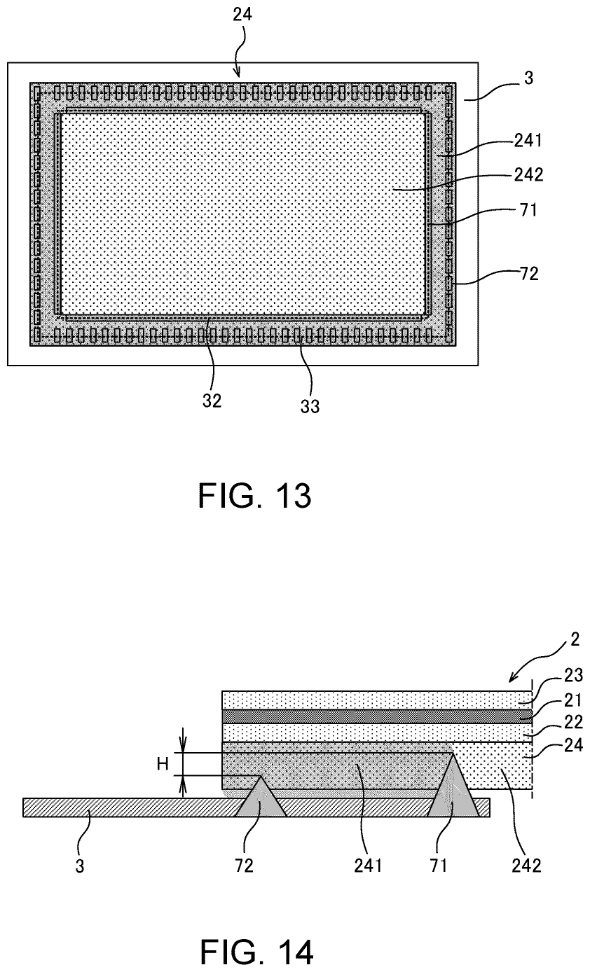

Shapes of bonding portions described in the first embodiment and the first to fourth modified examples of the first embodiment are each described as an individual embodiment, but may be appropriately combined. That is, the first and second bonding portions 71 and 72 may have any shape, such as a continuous shape over an entire circumference, a dotted line shape with intervals, a shape extending in a vertical direction, a shape in which an edge portion is discontinuous, etc., and the combination may also be arbitrarily selected. In addition, the first and second bonding portions 71 and 72 may have different shapes in a longitudinal and transverse directions of the metal support layer 24. For example, as shown in FIG. 13, the second bonding portion 72 may be disposed in plural so as to extend in a direction perpendicular to the first annular line 32 while having intervals in the longitudinal direction of the metal support layer 24, and may be disposed in the dotted line shape with intervals in the transverse direction.

### Second Embodiment

Referring to FIG. 14, a solid oxide fuel cell 100 of a second embodiment is described. In the present embodiment, in a first bonding portion 71 and a second bonding portion 72, it is different from the first embodiment in that a welding depth is different. In addition, the same drawing symbols are cited to the same elements as in the first embodiment, and the description will be omitted.

FIG. 14 is an enlarged schematic view of a bonding area of a power generation cell 2 and a frame 3 and corresponds to a cross-sectional view taken along line A-A in FIG. 2.

As shown in FIG. 14, the frame 3 is welded to a metal support layer 24 in a first bonding portion 71 at an inner peripheral side and a second bonding portion 72 at an outer peripheral side of a filled portion 241. A welding depth (melting depth) in the first bonding portion 71 is greater by H than a welding depth (melting depth) in the second bonding portion 72.

As such, since the welding depth of the second bonding portion 72 at the outer peripheral side is made smaller, when filling a filling material from a side surface of the metal support layer 24, an interference with the filling of the filling material by the second bonding portion 72 is suppressed, and it becomes easy to fill the filling material from the side surface of the metal support layer 24. Meanwhile, since the welding depth of the first bonding portion 71 at the inner peripheral side is made greater, the first bonding portion 71 prevents the filling material from penetrating into a central portion of the power generation cell 2. That is, the intrusion of the insulating filling material into the central portion of the power generation cell 2 is prevented, thereby suppressing the reduction of the area of an active region (portion that contributes to power generation) of the power generation cell 2.

According to the solid oxide fuel cell 100 of the second embodiment described above, the following effects may be obtained.

In the solid oxide fuel cell 100, the metal frame 3 is welded to the porous metal support layer 24 in the first bonding portion 71 and the second bonding portion 72 disposed of the outer peripheral side than the first bonding portion 71, and the welding depth of the first bonding portion 71 is greater than the welding depth at the second bonding portion 72. As such, the welding depth of the second bonding portion 72 at the outer peripheral side is made smaller, it becomes easier to fill the filling material from the side surface of the porous metal support layer 24, thereby more reliably filling the filled portion 241.

In addition, the welding depth of the first bonding portion 71 at the inner peripheral side is made greater, it is possible to prevent the filling material from intruding into the center portion of the power generation cell 2, and the area reduction of the active region of the power generation cell 2 may be suppressed.

### Third Embodiment

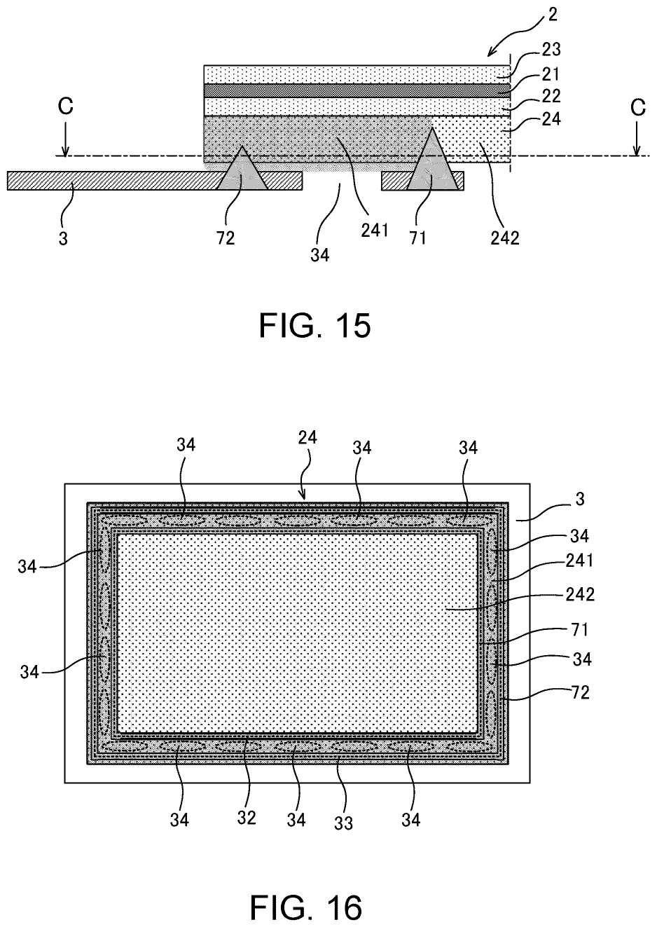

Referring to FIGS. 15 and 16, a solid oxide fuel cell 100 according to a third embodiment will be described. In the present embodiment, it is different from other embodiments in that a metal frame 3 includes an opening portion 34. In addition, the same drawing symbols are cited to the same elements as in other embodiments, and the description will be omitted.

FIG. 15 is an enlarged schematic view of a bonding portion of a power generation cell 2 and a frame 3, and corresponds to a cross-sectional view taken along line A-A in FIG. 2. In addition, FIG. 16 is a cross-sectional view of an entire porous metal support layer 24 taken along line C-C in FIG. 15.

As shown in FIGS. 15 and 16, the frame 3 is welded to the metal support layer 24 in a first bonding portion 71 of an inner peripheral side and a second bonding portion 72 of an outer peripheral side of a filled portion 241. In addition, the frame 3 includes a plurality of opening portions 34 opened downwards between the first bonding portion 71 and the second bonding portion 72.

As such the frame 3 includes the opening portion 34 between the first bonding portion 71 and the second bonding portion 72, in the case of filling a filling material from the side surface of the metal support layer 24, when the filling material is filled in the entire metal support layer 24 (i.e., the filled portion 241) between the first bonding portion 71 and the second bonding portion 72, the filling material reaches the opening portion 34. That is, it may be confirmed from the opening portion 34 that the filling material is filled between the first bonding portion 71 and the second bonding portion 72. Therefore, the filled portion 241 may be filled more reliably.

In addition, also for the present embodiment, it is preferable that a welding depth in the first bonding portion 71 is greater than a welding depth in the second bonding portion 72 but is not necessarily limited thereto, and for example, the welding depth of the first bonding portion 71 and the second bonding portion 72 may be the same.

According to the solid oxide fuel cell 100 of the third embodiment described above, the following effects may be obtained.

In the solid oxide fuel cell 100, the metal frame 3 includes the opening portion 34 between the first bonding portion 71 and the second bonding portion 72. Accordingly, since it may be confirmed from the opening portion 34 that the filling material is filled between the first bonding portion 71 and the second bonding portion 72, the filling to the filled portion 241 may be more reliable. That is, a gas leakage from a side surface of the metal support layer 24 may be further prevented.

Although the embodiments of the present invention have been described above, the embodiments are merely a part of application examples and is not intended to limit the technical scope of the present invention to the specific configurations of the embodiments.

Each of the embodiments described above is described as an individual embodiment, but the embodiments may be combined appropriately.

1. A solid oxide fuel cell in which a power generation cell composed of a first electrode layer, a solid electrolyte layer laminated on the first electrode layer, a second electrode layer laminated on the solid electrolyte layer, and a porous metal support layer supporting the first electrode layer is laminated in plural, the solid oxide fuel cell comprising:
a metal frame provided under the porous metal support layer,
wherein the porous metal support layer includes a filled portion which is a region of which holes are filled with a filling material in an outer peripheral portion of the porous metal support layer thereof,
the metal frame is bonded to the filled portion of the porous metal support layer with a bonding portion interposed therebetween, and
the bonding portion includes a first bonding portion formed along the outer peripheral portion of the porous metal support layer and a second bonding portion disposed to be spaced apart from the first bonding portion at an outer peripheral side than the first bonding portion.

2. The solid oxide fuel cell of claim 1,
wherein the metal frame is welded to the porous metal support layer at the first bonding portion and the second bonding portion, and
a welding depth in the first bonding portion is greater than a welding depth in the second bonding portion.

3. The solid oxide fuel cell of claim 1,
wherein, when seen in a laminating direction, the first bonding portion is disposed on a first annular line having a ring shape, and
the second bonding portion is disposed on a second annular line that is a ring shape line positioned at an outer periphery side than the first annular line.

4. The solid oxide fuel cell of claim 3,
wherein the first bonding portion is formed continuously over an entire circumference of the first annular line, and
the second bonding portion is disposed continuously over an entire circumference of the second annular line.

5. The solid oxide fuel cell of claim 3,
wherein the second bonding portion is disposed in a dotted line shape with intervals on the second annular line.

6. The solid oxide fuel cell of claim 3,
wherein the second bonding portion is disposed in plural to be spaced apart from each other on the second annular line and is disposed so as to extend in a direction perpendicular to the first annular line.

7. The solid oxide fuel cell of claim 3,
wherein the first bonding portion is disposed in a dotted line shape with intervals on the first annular line.

8. The solid oxide fuel cell of claim 3,
wherein the second bonding portion is disposed in a dotted line shape with intervals on the second annular line,
the first bonding portion is disposed in a dotted line shape with intervals on the first annular line, and
when seen in the laminating direction, the first bonding portion and the second bonding portion are disposed in a zigzag shape.

9. The solid oxide fuel cell of claim 3,
wherein the first bonding portion is disposed on the first annular line so that an edge portion thereof is discontinuous.

10. The solid oxide fuel cell of claim 1,
wherein the metal frame includes an opening portion between the first bonding portion and the second bonding portion.

11. The solid oxide fuel cell of claim 1,
wherein a linear expansion coefficient of the filling material is smaller than a linear expansion coefficient of a porous metal material constituting the porous metal support layer.
